(19) United States
(12) Patent Application Publication
(10) Pub. No.: US 2016/0288543 A1
(43) Pub. Date: Oct. 6, 2016

(54) TRANSPORT APPARATUS, IMAGE RECORDING APPARATUS AND TRANSPORT METHOD

(71) Applicant: SCREEN HOLDINGS CO., LTD., Kyoto (JP)

(72) Inventors: Mitsuhiro YOSHIDA, Kyoto (JP); Masaki YOSHIOKA, Kyoto (JP); Hiroaki USUMOTO, Kyoto (JP)

(21) Appl. No.: 15/062,913

(22) Filed: Mar. 7, 2016

(30) Foreign Application Priority Data
Mar. 30, 2015 (JP) 2015-067946

(51) Int. Cl. B41J 13/00; B65H 23/04

(52) U.S. Cl. CPC B41J 13/0009; B65H 23/046

(57) ABSTRACT

A transport apparatus includes a correction mechanism, a detector, and a meandering attenuator. The detector detects a widthwise position of elongated strip-shaped printing paper. The correction mechanism corrects the widthwise position of the printing paper, based on a detection result from the detector. The meandering attenuator is disposed upstream or downstream of the correction mechanism as seen in a transport direction. The meandering attenuator includes a plurality of attenuation rollers rotating while being in contact with the printing paper. When the printing paper passes over the attenuation rollers, the meandering of the printing paper is attenuated by the friction between the attenuation rollers and the printing paper. Thus, meandering exceeding the correction capability of the correction mechanism and new meandering occurring in the correction mechanism are attenuated.

### BACKGROUND OF THE INVENTION

1. Field of the Invention

The present invention relates to a transport apparatus for transporting an elongated strip-shaped recording medium along the length thereof, an image recording apparatus including the transport apparatus, and a method of transporting an elongated strip-shaped recording medium along the length thereof.

2. Description of the Background Art

An inkjet image recording apparatus which records an image on elongated strip-shaped printing paper by ejecting ink from a plurality of recording heads while transporting the printing paper along the length thereof has heretofore been known. The image recording apparatus of this type includes a correction mechanism for correcting a widthwise position of the printing paper for the purpose of suppressing the meandering of the printing paper.

A conventional image recording apparatus including such a correction mechanism is disclosed, for example, in Japanese Patent Application Laid-Open No. 2014-34205. The apparatus disclosed in Japanese Patent Application Laid-Open No. 2014-34205 includes an EPC® (Edge Position Control) for controlling the meandering of paper, and a meandering amount detector for use in the feedback of the amount of meandering (with reference to paragraph 0019 and FIG. 1). In the image recording apparatus of this type, an edge sensor for detecting the position of an edge of printing paper, for example, is used as the meandering amount detector. However, elongated strip-shaped printing paper is generally obtained by cutting wide strip-shaped base paper to a desired width with a rotating cutter while transporting the base paper. There are hence cases in which the shape of the edges themselves of the printing paper has periodic undulations corresponding to the rotation period of the cutter. In such cases, the edge sensor detects not only the overall misregistration of the printing paper in the width direction but also the periodic undulations of the edge shape to perform an unwanted correction corresponding to the periodic undulations. In this case, the printing paper subjected to the correction meanders at a frequency corresponding to the undulations of the edges.

Also, there are cases in which printing paper transported in the image recording apparatus meanders so greatly as to exceed the correction capability of the correction mechanism. In such cases, the correction mechanism is incapable of sufficiently removing the meandering of the printing paper, so that the printing paper remains meandering after the correction. When the printing paper remains meandering under a recording head, the position at which ink ejected from the recording head is printed on the printing paper does not coincide with a desired position. This becomes a factor in decreasing the quality of images.

### SUMMARY OF THE INVENTION

It is therefore an object of the present invention to provide a transport apparatus, an image recording apparatus, and a transport method which are capable of attenuating the meandering of a recording medium in a position upstream or downstream of a correction mechanism as seen in a transport direction. A first aspect of the present invention is intended for a transport apparatus for transporting an elongated strip-shaped recording medium along the length thereof. The transport apparatus comprises: a detector for detecting a widthwise position of the recording medium, the detector providing a detection result indicative of the widthwise position; a correction mechanism for correcting the widthwise position of the recording medium, based on the detection result from the detector; and a meandering attenuator for attenuating the periodic meandering of the recording medium in a position upstream or downstream of the correction mechanism as seen in a transport direction, the meandering attenuator including a plurality of attenuation rollers rotating while being in contact with the recording medium.

A second aspect of the present invention is intended for an image recording apparatus comprising: a transport apparatus for transporting an elongated strip-shaped recording medium along the length thereof; and a recording head for recording an image on a surface of the recording medium transported by the transport apparatus, the transport apparatus including a detector for detecting a widthwise position of the recording medium, a correction mechanism for correcting the widthwise position of the recording medium, based on a detection result from the detector, and a meandering attenuator for attenuating the periodic meandering of the recording medium in a position upstream or downstream of the correction mechanism as seen in a transport direction, the meandering attenuator including a plurality of attenuation rollers rotating while being in contact with the recording medium.

A third aspect of the present invention is intended for a method of transporting an elongated strip-shaped recording medium along the length thereof. The method comprises the steps of: a) detecting a widthwise position of the recording medium; b) correcting the widthwise position of the recording medium in a correction position, based on a detection result obtained in the step a); and c) attenuating the periodic meandering of the recording medium in a position upstream or downstream of the correction position as seen in a transport direction, wherein a plurality of attenuation rollers are rotated while being in contact with the recording medium in the step c).

According to the first and second aspects of the present invention, the meandering of the recording medium is attenuated by causing the recording medium to pass over the attenuation rollers of the meandering attenuator.

According to the third aspect of the present invention, the meandering of the recording medium is attenuated by causing the recording medium to pass over the attenuation rollers in the step c).

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a diagram showing a configuration of an image recording apparatus according to a first preferred embodiment of the present invention;

FIG. 2 is a perspective view of a correction mechanism according to the first preferred embodiment;

FIG. 3 is a schematic view of an edge sensor according to the first preferred embodiment;

FIG. 4 is a block diagram of a control system according to the first preferred embodiment;

FIG. 5 is a diagram showing a configuration of the correction mechanism and a meandering attenuator according to the first preferred embodiment;

FIG. 6 is a flow diagram showing a procedure for a meandering correction in the correction mechanism and the meandering attenuator according to the first preferred embodiment;

FIG. 7 is a graph showing the effect of attenuating the meandering of printing paper by means of rollers;

FIG. 8 is a diagram showing a configuration of the meandering attenuator and the correction mechanism according to a second preferred embodiment of the present invention;

FIG. 9 is a flow diagram showing a procedure for the meandering correction in the meandering attenuator and the correction mechanism according to the second preferred embodiment; and

FIG. 10 is a diagram showing a configuration of the correction mechanism and the meandering attenuator according to a modification of the present invention.

### DESCRIPTION OF THE PREFERRED EMBODIMENTS

Preferred embodiments according to the present invention will now be described with reference to the drawings.

### 1. First Preferred Embodiment

### 1-1. Configuration of Image Recording Apparatus

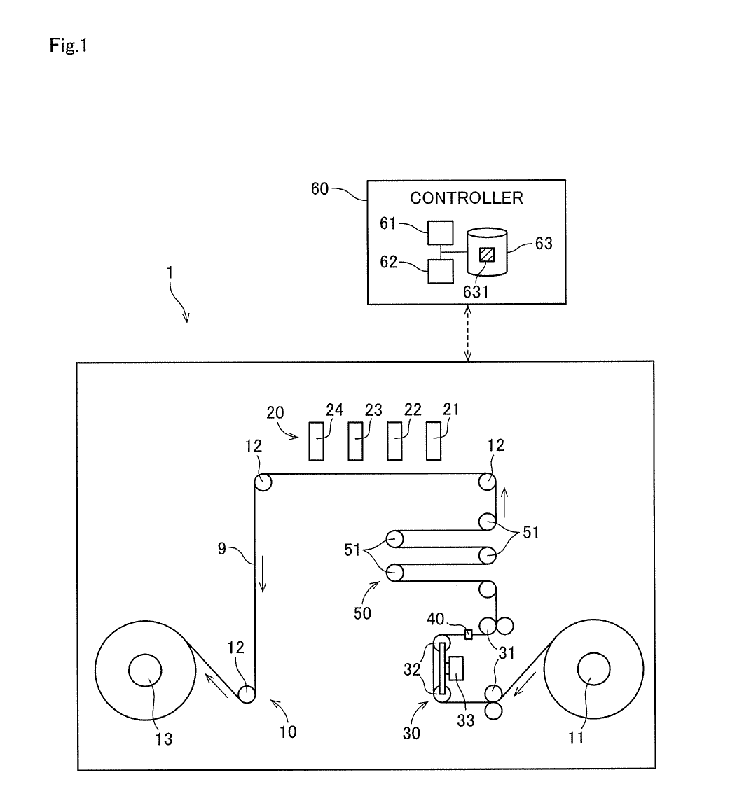

FIG. 1 is a diagram showing a configuration of an image recording apparatus 1 according to a first preferred embodiment of the present invention. This image recording apparatus 1 is an inkjet printing apparatus which records a multi-color image on printing paper 9 that is an elongated strip-shaped recording medium by ejecting ink from a plurality of recording heads 21 to 24 toward the printing paper 9 while transporting the printing paper 9. As shown in FIG. 1, the image recording apparatus 1 includes a transport mechanism 10, an image recorder 20, a correction mechanism 30, an edge sensor 40, a meandering attenuator 50, and a controller 60.

The transport mechanism 10, the correction mechanism 30, the edge sensor 40, and the meandering attenuator 50 constitute a transport apparatus for transporting the printing paper 9 while suppressing the meandering of the printing paper 9 in the first preferred embodiment.

The transport mechanism 10 is a mechanism for transporting the printing paper 9 in a transport direction along the length of the printing paper 9. The transport mechanism 10 according to the first preferred embodiment includes an unwinder 11, a plurality of transport rollers 12, and a winder 13. The printing paper 9 is unwound from the unwinder 11, and is transported along a transport path formed by the transport rollers 12. Each of the transport rollers 12 rotates about a horizontal axis to guide the printing paper 9 downstream along the transport path. The transported printing paper 9 is wound and collected on the winder 13.

As shown in FIG. 1, the printing paper 9 is moved under the image recorder 20 in substantially parallel relation to a direction in which the recording heads 21 to 24 are arranged. During this movement, a recording surface of the printing paper 9 faces upwardly (toward the recording heads 21 to 24). The printing paper 9 runs over the transport rollers 12 while being held under tension. This prevents slack and wrinkles in the printing paper 9 during the transport.

The image recorder 20 ejects ink droplets toward the printing paper 9 transported by the transport mechanism 10. The image recorder 20 according to the first preferred embodiment includes a first recording head 21, a second recording head 22, a third recording head 23, and a fourth recording head 24 which are equally spaced along the transport path of the printing paper 9. A lower surface of each of the recording heads 21 to 24 includes a plurality of nozzles arranged parallel to a width direction (a horizontal direction orthogonal to the transport direction) of the printing paper 9. The first, second, third and fourth recording heads 21, 22, 23 and 24 eject ink droplets of four colors, i.e., K (black), C (cyan), M (magenta) and Y (yellow), respectively, which serve as color components of a multi-color image from the nozzles toward an upper surface of the printing paper 9.

Each of the four recording heads 21 to 24 ejects ink droplets to thereby record a single-color image on the upper surface of the printing paper 9. A multi-color image is formed on the upper surface of the printing paper 9 by superimposing the four single-color images. If the printing paper 9 meanders, the widthwise positions at which the ink droplets ejected from the four recording heads 21 to 24 are printed on the printing paper 9 do not coincide with each other, so that the image quality of a printed product is lowered. Controlling such misregistration between the single-color images on the printing paper 9 within an allowable range is an important factor for improvements in print quality of the image recording apparatus 1.

A dryer unit for drying the ink adhering to the recording surface of the printing paper 9 may be further provided downstream of the recording heads 21 to 24 as seen in the transport direction. For example, a mechanism that brings the printing paper 9 into contact with a heated roller and a mechanism that blows a heated gas toward the printing paper 9 are used for the dryer unit. When the ink is photo-curable, a mechanism that irradiates the ink with light may be used for the dryer unit.

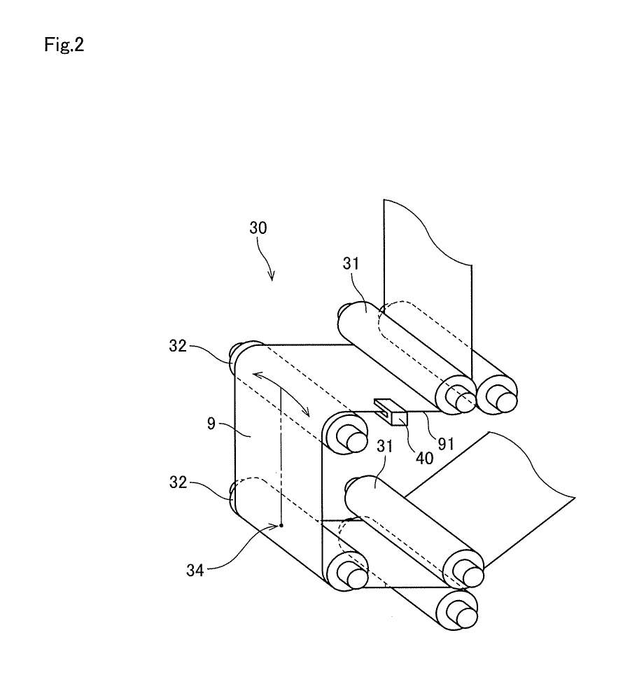

The correction mechanism 30 corrects the widthwise position of the printing paper 9. In the first preferred embodiment, the correction mechanism 30 is disposed in a correction position upstream of the image recorder 20 as seen in the transport direction. FIG. 2 is a perspective view of the correction mechanism 30. As shown in FIGS. 1 and 2, the correction mechanism 30 according to the first preferred embodiment includes a pair of stationary rollers 31 and a pair of guide rollers 32. Each of the stationary rollers 31 rotates about a horizontal axis in a fixed position.

After passing over an upstream one of the stationary rollers 31, the printing paper 9 passes over an upstream one of the guide rollers 32, so that the transport orientation of the printing paper 9 is changed by 90 degrees. Thereafter, the printing paper 9 passes over a downstream one of the guide rollers 32, so that the transport orientation of the printing paper 9 is further changed by 90 degrees. Thereafter the printing paper 9 passes over a downstream one of the stationary rollers 31. As shown in FIG. 1, the guide rollers 32 are connected to a pivot mechanism 33 (not shown in FIG. 2). When the pivot mechanism 33 is put into operation, the guide rollers 32 pivot in the width direction of the printing paper 9 about a pivot 34 positioned near the middle of the upstream guide roller 32.

The edge sensor 40 is a detector for detecting the widthwise position of the printing paper 9. The edge sensor 40 is disposed between the downstream guide roller 32 and the downstream stationary roller 31 in the correction mechanism 30. The edge sensor 40, however, may be provided in other positions in the correction mechanism 30. Alternatively, the edge sensor 40 may be provided on a transport path upstream or downstream of the correction mechanism 30 as seen in the transport direction. When the widthwise position of the printing paper 9 is out of its standard position, the position of an edge 91 of the printing paper 9 with respect to the edge sensor 40 is changed. The edge sensor 40 senses the position of the edge 91 to detect the amount of widthwise misregistration of the printing paper 9.

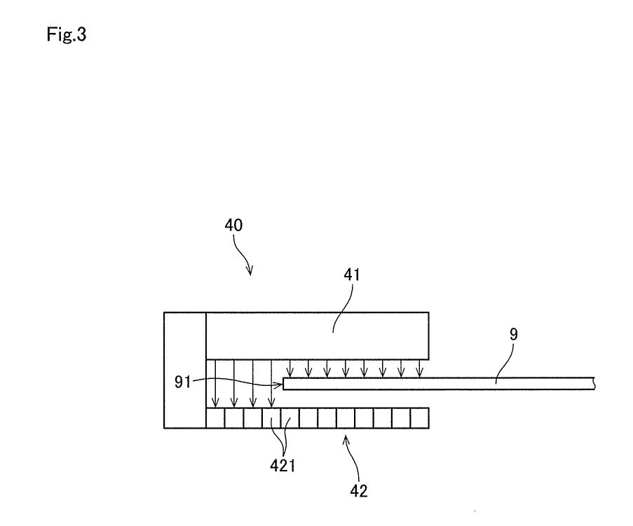

FIG. 3 is a schematic view of an example of the edge sensor 40. The edge sensor 40 of FIG. 3 includes a light emitter 41 positioned over the edge 91 of the printing paper 9, and a line sensor 42 positioned under the edge 91. The light emitter 41 emits parallel light beams downwardly. The line sensor 42 includes a plurality of light receiving elements 421 arranged in the width direction of the printing paper 9. Outside the edge 91 of the printing paper 9, light beams emitted from the light emitter 41 enter the light receiving elements 421, so that the light receiving elements 421 detect the light beams, as shown in FIG. 3. Inside the edge 91, light beams emitted from the light emitter 41 are intercepted by the printing paper 9, so that the light receiving elements 421 detect no light beams. The edge sensor 40 detects the position of the edge 91 of the printing paper 9, based on whether the light receiving elements 421 detect light beams or not.

The controller 60 operates the pivot mechanism 33, based on the detection result from the edge sensor 40. Thus, the widthwise position of the printing paper 9 is corrected to approach the standard position. The structure of the correction mechanism 30 is not limited to that shown in FIG. 2. For example, the correction mechanism 30 may be configured to translate a roller in the width direction of the printing paper 9 to displace the printing paper 9 in the width direction thereof. The detection method of the edge sensor 40 is not limited to that shown in FIG. 3. For example, a reflection type optical sensor, an ultrasonic sensor and a contact type sensor may be used as the edge sensor 40. The detector according to the present invention may be a sensor for detecting other than edges of the printing paper 9. For example, the detector may be of the type which reads or scans marks provided on the upper surface of the printing paper 9 or the grain (direction) of fibers of the printing paper 9 itself by means of a high-definition camera.

The meandering attenuator 50 is a mechanism for attenuating the periodic meandering of the printing paper 9. In the first preferred embodiment, the meandering attenuator 50 is disposed downstream of the correction mechanism 30 as seen in the transport direction and upstream of the image recorder 20 as seen in the transport direction. As shown in FIG. 1, the meandering attenuator 50 includes a plurality of attenuation rollers 51. When the printing paper 9 passes over the attenuation rollers 51, meandering components having a specific frequency of the printing paper 9 are attenuated by the friction between the printing paper 9 and the attenuation rollers 51. More details on the configuration of the meandering attenuator 50 will be described later. The controller 60 controls the operations of the components in the image recording apparatus 1. As conceptually shown in FIG. 1, the controller 60 includes a computer having an arithmetic processor 61 such as a CPU, a memory 62 such as a RAM, and a storage part 63 such as a hard disk drive. A computer program 631 for executing a printing process while correcting the meandering of the printing paper 9 is installed in the storage part 63.

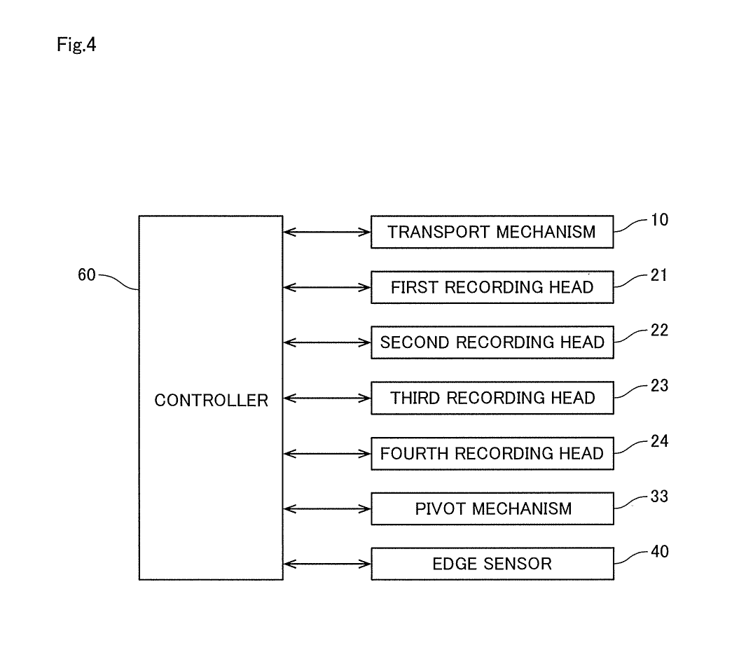

FIG. 4 is a block diagram showing a configuration of connection between the controller 60 and the components in the image recording apparatus 1. As shown in FIG. 4, the controller 60 is electrically connected to the transport mechanism 10, the four recording heads 21 to 24, the pivot mechanism 33, and the edge sensor 40 described above. The controller 60 temporarily reads the computer program 631 stored in the storage part 63 onto the memory 62. The arithmetic processor 61 performs arithmetic processing based on the computer program 631, so that the controller 60 controls the operations of the aforementioned components. Thus, the printing process in the image recording apparatus 1 proceeds.

### 1-2. Details on Configuration of Meandering Attenuator

Next, details on the configuration of the meandering attenuator 50 will be described.

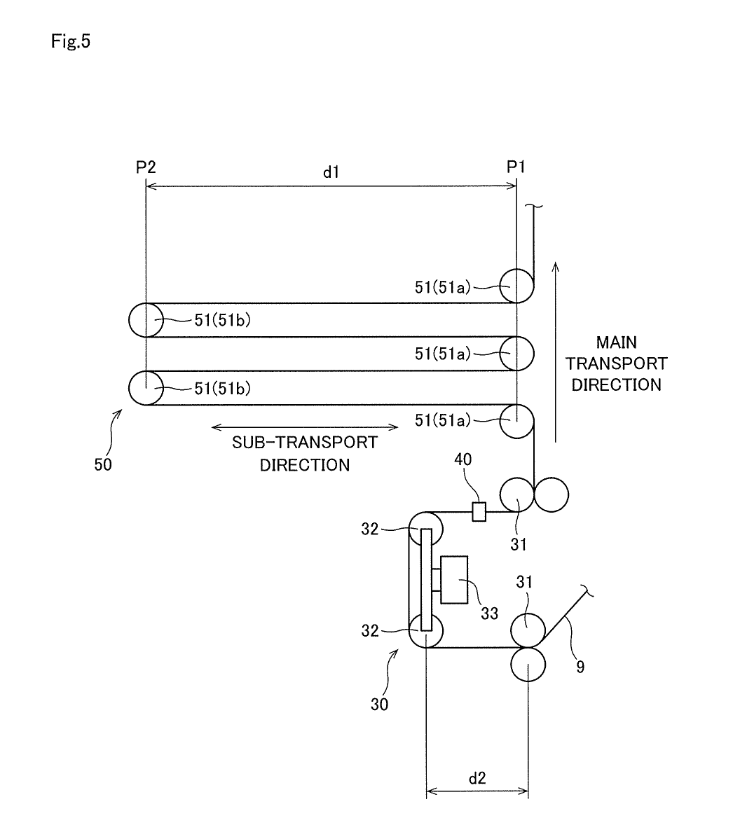

FIG. 5 is a diagram showing a configuration of the correction mechanism 30 and the meandering attenuator 50. As indicated by arrows in FIG. 5, the transport direction of the printing paper 9 before and after the meandering attenuator 50 is referred to hereinafter as a “main transport direction”, and a direction orthogonal to the main transport direction and the width direction of the printing paper 9 is referred to hereinafter as a “sub-transport direction”. The meandering attenuator 50 causes the printing paper 9 transported in the main transport direction after passing through the correction mechanism 30 to travel back and forth a plurality of times in the sub-transport direction. Thereafter, the meandering attenuator 50 transports the printing paper 9 again in the main transport direction.

As shown in FIG. 5, the meandering attenuator 50 according to the first preferred embodiment includes the plurality of (in the example of FIG. 5, five) attenuation rollers 51. Each of the attenuation rollers 51 is a cylindrical roller extending in the width direction of the printing paper 9. During the transport of the printing paper 9, each of the attenuation rollers 51 is driven to rotate about a horizontal axis while being in contact with the printing paper 9.

The attenuation rollers 51 of the meandering attenuator 50 include at least one first attenuation roller 51a (in the example of FIG. 5, three first attenuation rollers 51a) disposed in a first position P1 as seen in the sub-transport direction, and at least one second attenuation roller 51b (in the example of FIG. 5, two second attenuation rollers 51b) disposed in a second position P2 different from the first position P1 as seen in the sub-transport direction. The printing paper 9 runs over the first and second attenuation rollers 51a and 51b in an alternating manner. Thus, the printing paper 9 travels back and forth at least once between the first position P1 and the second position P2 as seen in the sub-transport direction.

When the printing paper 9 passes over the attenuation rollers 51 in this manner, the meandering of the printing paper 9 is attenuated by the friction between the attenuation rollers 51 and the printing paper 9. The frequency and attenuation rate of the meandering to be attenuated are varied depending on a distance d1 between the attenuation rollers 51, the number of attenuation rollers 51, the transport speed of the printing paper 9, and the like. In particular, high-frequency meandering components are removed at a high attenuation rate. In other words, the meandering attenuator 50 comprised of the attenuation rollers 51 functions as a low-pass filter for the meandering of the printing paper 9.

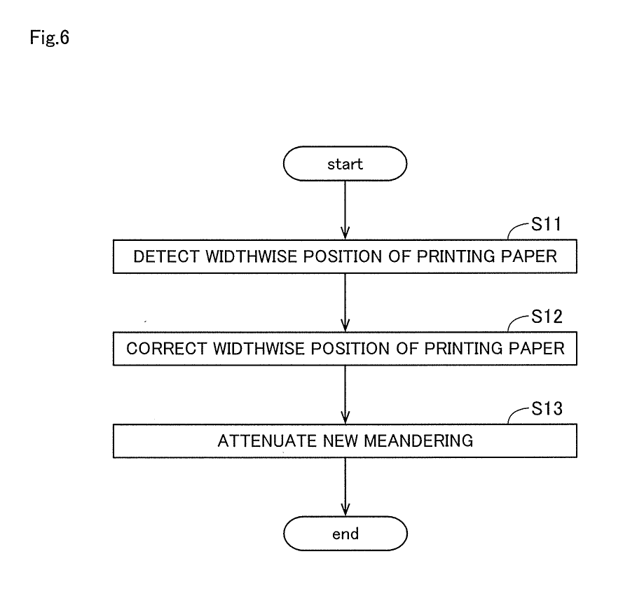

In the first preferred embodiment, the meandering attenuator 50 is disposed downstream of the correction mechanism 30 as seen in the transport direction. FIG. 6 is a flow diagram showing a procedure for the meandering correction performed on the printing paper 9 in the correction mechanism 30 and the meandering attenuator 50. In the first preferred embodiment, the printing paper 9 unwound from the unwinder 11 is initially transported to the correction mechanism 30. The edge sensor 40 always detects the widthwise position of the printing paper 9 transported to the correction mechanism 30 (Step S11). Based on the detection result from the edge sensor 40, the correction mechanism 30 pivots the guide rollers 32. This corrects the widthwise position of the printing paper 9 (Step S12).

At this time, when the edge shape of the printing paper 9 has periodic undulations, the edge sensor 40 detects not only the overall misregistration of the printing paper in the width direction but also the periodically varying edge shape of the printing paper 9. Thus, the correction mechanism 30 provides needless displacement in the width direction to the printing paper 9 in Step S12. As a result, new meandering occurs in the printing paper 9. The new meandering has a frequency corresponding to the period of the edge shape of the printing paper 9.

After passing through the correction mechanism 30, the printing paper 9 is subsequently transported to the meandering attenuator 50. In the meandering attenuator 50, the printing paper 9 travels back and forth in the sub-transport direction while being in contact with the attenuation rollers 51. This attenuates the new meandering of the printing paper 9 occurring in Step S12 (in Step S13). The frequency of the new meandering is often higher than the meandering frequency to be generally corrected by the correction mechanism 30. Thus, the meandering attenuator 50 having the property of the low-pass filter is capable of effectively attenuating the new meandering.

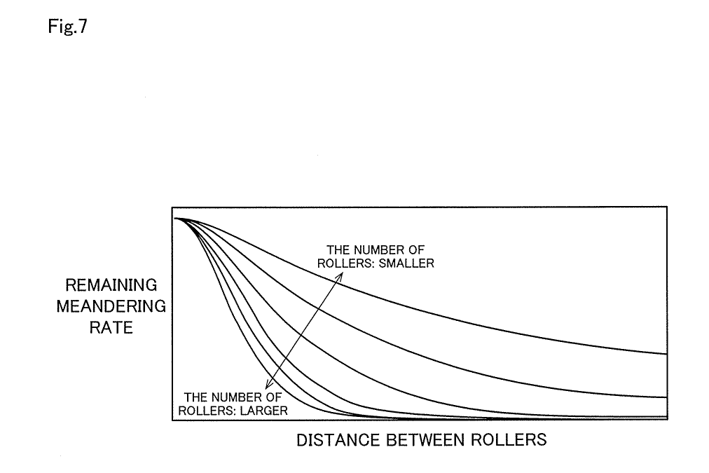

FIG. 7 is a graph showing results obtained by approximate calculation using a transfer function and indicating how much the meandering of the printing paper 9 is attenuated when the printing paper 9 is passed over a plurality of rollers. The abscissa of FIG. 7 represents a distance between the rollers, and the ordinate of FIG. 7 represents how much the meandering components having a specific frequency remain (remaining rate) after the printing paper 9 passes over the rollers. Curves in FIG. 7 represent results for the different numbers of rollers. As shown in FIG. 7, the remaining rate of the meandering components decreases as the number of rollers increases and as the distance between the rollers increases. In this manner, the meandering components having a desired frequency are attenuated to a desired rate by properly setting the number of rollers and the distance between the rollers.

The undulations of the edge shape of the printing paper 9 correspond to the rotation period of a cutter during the cutting of the printing paper 9. Thus, the meandering frequency resulting from the edge shape of the printing paper 9 can be previously estimated. When the number of attenuation rollers 51 and the distance between the attenuation rollers 51 are set so that the meandering having such a frequency is attenuated at a high attenuation rate, the new meandering of the printing paper 9 occurring in the correction mechanism 30 is effectively attenuated.

In the first preferred embodiment, the attenuation rollers 51 are substantially equally spaced apart relative to each other along the transport path of the printing paper 9. The arrangement of the attenuation rollers 51 regularly spaced in this manner causes the attenuation rate of the meandering to vary in accordance with the number of attenuation rollers 51. This makes it easy to set the attenuation rate of the meandering to a desired value by adjusting the number of attenuation rollers 51.

In the first preferred embodiment, the transport orientation of the printing paper 9 is changed by approximately 180 degrees in each of the attenuation rollers 51. This reduces the size of the meandering attenuator 50 as measured in the main transport direction, and also increases the contact area of the printing paper 9 with each of the attenuation rollers 51. Thus, the effect of attenuating the meandering of the printing paper 9 is further enhanced.

As may be seen from the graph of FIG. 7, it is preferable to increase the distance dl between the attenuation rollers 51 in the meandering attenuator 50 for the purpose of enhancing the effect of attenuating the meandering. For example, as shown in FIG. 5, the distance dl between the attenuation rollers 51 in the meandering attenuator 50 is preferably greater than a distance d2 between the stationary rollers 31 and the guide rollers 32 in the correction mechanism 30. The distance d1 between the attenuation rollers 51 in the meandering attenuator 50 is more preferably not less than twice the distance d2 between the stationary rollers 31 and the guide rollers 32 in the correction mechanism 30, and is further preferably not less than three times the distance d2.

As may be seen from the graph of FIG. 7, it is preferable to increase the number of attenuation rollers 51 in the meandering attenuator 50 for the purpose of enhancing the effect of attenuating the meandering. Specifically, the number of attenuation rollers 51 in the meandering attenuator 50 is preferably not less than four, for example. The number of attenuation rollers 51 in the meandering attenuator 50 is more preferably not less than five, and is further preferably not less than six.

### 2. Second Preferred Embodiment

Next, a second preferred embodiment according to the present invention will be described mainly on differences from the first preferred embodiment.

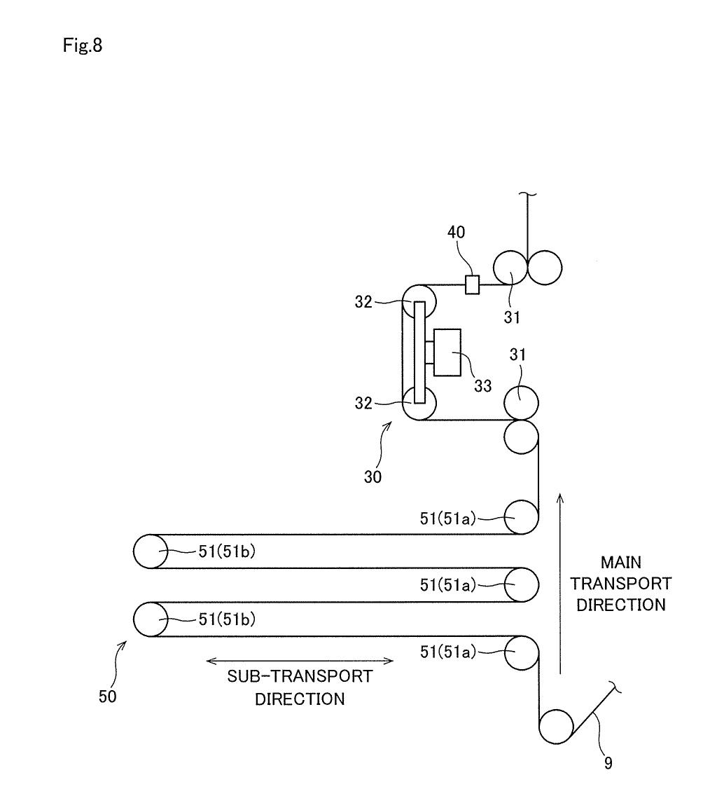

FIG. 8 is a diagram showing a configuration of the meandering attenuator 50 and the correction mechanism 30 according to the second preferred embodiment. In the second preferred embodiment, the meandering attenuator 50 is disposed upstream of the correction mechanism 30 as seen in the transport direction. The meandering attenuator 50 causes the printing paper 9 unwound from the unwinder 11 and transported in the main transport direction to travel back and forth a plurality of times in the sub-transport direction. Thereafter, the meandering attenuator 50 changes the transport orientation again to the main transport direction to transport the printing paper 9 to the correction mechanism 30.

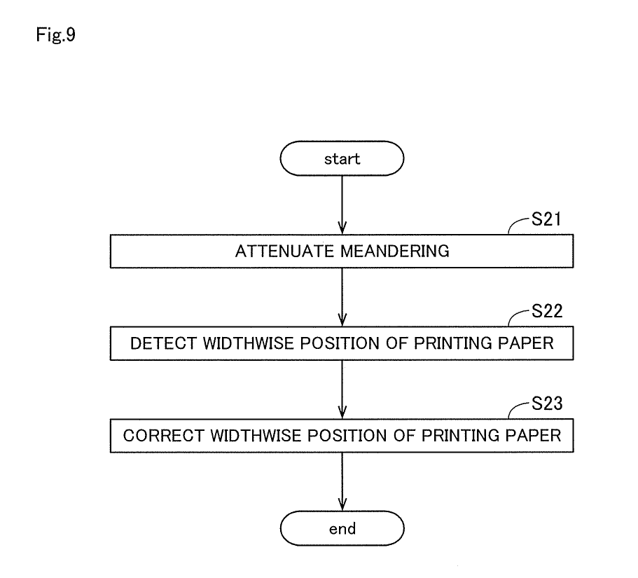

FIG. 9 is a flow diagram showing a procedure for the meandering correction performed on the printing paper 9 in the meandering attenuator 50 and the correction mechanism 30 shown in FIG. 8. In the second preferred embodiment, the printing paper 9 passes through the meandering attenuator 50 in a position upstream of the correction mechanism 30 as seen in the transport direction. In the meandering attenuator 50, the printing paper 9 travels back and forth in the sub-transport direction while being in contact with the attenuation rollers 51. This attenuates the meandering of the printing paper 9 (in Step S21).

After passing through the meandering attenuator 50, the printing paper 9 is transported to the correction mechanism 30. The edge sensor 40 always detects the widthwise position of the printing paper 9 transported to the correction mechanism 30 (Step S22). Based on the detection result from the edge sensor 40, the correction mechanism 30 pivots the guide rollers 32. This corrects the widthwise position of the printing paper 9 (Step S23).

When the meandering of the printing paper 9 exceeds the correction capability of the correction mechanism 30, the second preferred embodiment is capable of attenuating the meandering in a position upstream of the correction mechanism 30.

Thus, the meandering of the printing paper 9 is corrected to fall within an allowable range in the correction mechanism 30. If great meandering occurs suddenly due to external vibrations and the like, the passage of the printing paper 9 through the meandering attenuator 50 and the correction mechanism 30 sufficiently reduces the meandering of the printing paper 9.

### 3. Modifications

While the preferred embodiments according to the present invention have been described hereinabove, the present invention is not limited to the aforementioned preferred embodiments.

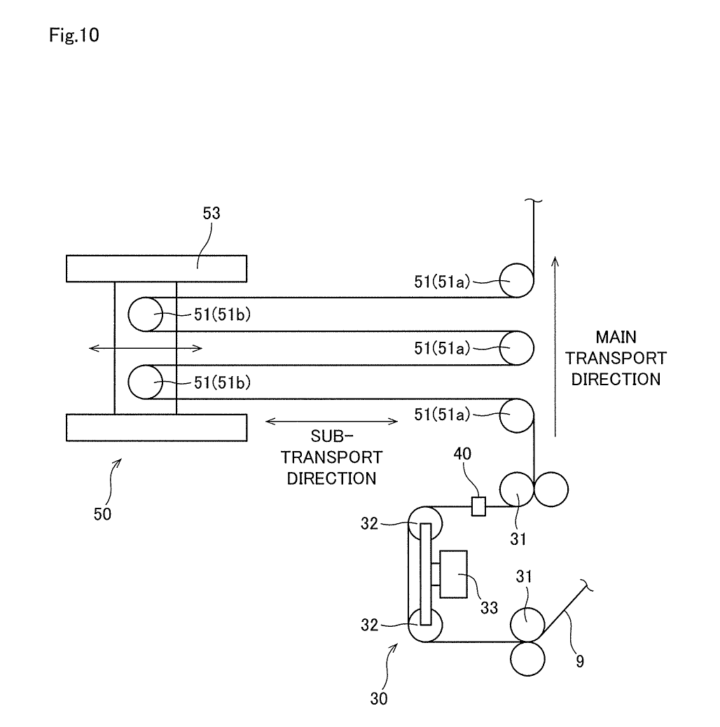

FIG. 10 is a diagram showing a configuration of the correction mechanism 30 and the meandering attenuator 50 according to a modification of the present invention. In the modification of FIG. 10, the positions of the plurality of first attenuation rollers 51a of the meandering attenuator 50 are fixed positions. The plurality of second attenuation rollers 51b are movable in the sub-transport direction. The second attenuation rollers 51b are moved integrally in the sub-transport direction, for example, by a common moving mechanism 53. The second attenuation rollers 51b may be moved using power of a motor and the like or manually by an operator. When an operator manually moves the second attenuation rollers 51b, the moving mechanism 53 may be configured to perform only the positioning of the second attenuation rollers 51b.

This easily varies a distance between the first attenuation rollers 51a and the second attenuation rollers 51b as seen in the sub-transport direction to thereby facilitate the operation of setting the distance between the attenuation rollers 51 to a distance depending on a desired attenuation rate.

In the aforementioned preferred embodiments, the meandering attenuator 50 is disposed in only one of the positions downstream and upstream of the correction mechanism 30 as seen in the transport direction. However, the meandering attenuator 50 may be disposed in each of the positions downstream and upstream of the correction mechanism 30 as seen in the transport direction. Further, the meandering attenuator 50 having the attenuation rollers 51 may be additionally provided in a position separated from the correction mechanism 30.

The correction mechanism 30, the edge sensor 40, and the meandering attenuator 50 are provided upstream of the recording heads 21 to 24 as seen in the transport direction in the aforementioned preferred embodiments. However, the correction mechanism 30, the edge sensor 40, and the meandering attenuator 50 may be provided downstream of the recording heads 21 to 24 as seen in the transport direction.

In the aforementioned preferred embodiments, the four recording heads 21 to 24 are provided in the image recording apparatus 1. However, the number of recording heads in the image recording apparatus 1 may be in the range of one to three or not less than five. For example, a recording head for ejecting ink of a spot color may be provided in addition to those for K, C, M and Y.

The aforementioned image recording apparatus 1 records an image on the printing paper 9 serving as a recording medium. However, the image recording apparatus according to the present invention may be configured to record an image on a sheet-like recording medium other than general paper (for example, a film made of resin, metal foil and glass). The image recording apparatus according to the present invention may be an apparatus which records an image on a recording medium by a method other than the inkjet method (for example, an electrophotographic process and exposure to light).

The components described in the aforementioned preferred embodiments and in the modifications may be consistently combined together, as appropriate.

While the invention has been described in detail, the foregoing description is in all aspects illustrative and not restrictive. It is understood that numerous other modifications and variations can be devised without departing from the scope of the invention.

What is claimed is:

1. A transport apparatus for transporting an elongated strip-shaped recording medium along the length thereof, comprising:
a detector for detecting a widthwise position of said recording medium, said detector providing a detection result indicative of the widthwise position;
a correction mechanism for correcting the widthwise position of said recording medium, based on said detection result from said detector; and
a meandering attenuator for attenuating the periodic meandering of said recording medium in a position upstream or downstream of said correction mechanism as seen in a transport direction,
said meandering attenuator including a plurality of attenuation rollers rotating while being in contact with said recording medium.

2. The transport apparatus according to claim 1, wherein
said attenuation rollers are substantially equally spaced apart relative to each other along a transport path of said recording medium.

3. The transport apparatus according to claim 2, wherein
a transport orientation of said recording medium is changed by approximately 180 degrees in each of said attenuation rollers.

4. The transport apparatus according to claim 3, wherein
said meandering attenuator is disposed downstream of said correction mechanism as seen in the transport direction.

5. The transport apparatus according to claim 3, wherein
said meandering attenuator is disposed upstream of said correction mechanism as seen in the transport direction.

6. The transport apparatus according to claim 3,
wherein said correction mechanism includes
a stationary roller rotating in a fixed position, and
a guide roller movable in the width direction; and
wherein a distance between the attenuation rollers in said meandering attenuator is greater than a distance between said stationary roller and said guide roller in said correction mechanism.

7. The transport apparatus according to claim 3, wherein
said attenuation rollers in said meandering attenuator include not less than four attenuation rollers.

8. The transport apparatus according to claim 3, wherein
said attenuation rollers include
at least one first attenuation roller disposed in a fixed position, and
at least one second attenuation roller disposed so that a distance from said at least one first attenuation roller is variable.

9. An image recording apparatus comprising:
a transport apparatus for transporting an elongated strip-shaped recording medium along the length thereof; and
a recording head for recording an image on a surface of said recording medium transported by said transport apparatus,
said transport apparatus including
a detector for detecting a widthwise position of said recording medium,
a correction mechanism for correcting the widthwise position of said recording medium, based on a detection result from said detector, and
a meandering attenuator for attenuating the periodic meandering of said recording medium in a position upstream or downstream of said correction mechanism as seen in a transport direction,
said meandering attenuator including a plurality of attenuation rollers rotating while being in contact with said recording medium.

10. The image recording apparatus according to claim 9, wherein
said correction mechanism and said meandering attenuator are disposed upstream of said recording head as seen in the transport direction.

11. A method of transporting an elongated strip-shaped recording medium along the length thereof, the method comprising the steps of:
a) detecting a widthwise position of said recording medium;
b) correcting the widthwise position of said recording medium in a correction position, based on a detection result obtained in said step a); and
c) attenuating the periodic meandering of said recording medium in a position upstream or downstream of said correction position as seen in a transport direction,
wherein a plurality of attenuation rollers are rotated while being in contact with said recording medium in said step c).

12. The method according to claim 11, wherein
said attenuation rollers are substantially equally spaced apart relative to each other along a transport path of said recording medium.

13. The method according to claim 12, wherein
a transport orientation of said recording medium is changed by approximately 180 degrees in each of said attenuation rollers in said step c).

14. The method according to claim 13, wherein
the periodic meandering of said recording medium is attenuated downstream of said correction position as seen in the transport direction in said step c).

15. The method according to claim 13, wherein
the periodic meandering of said recording medium is attenuated upstream of said correction position as seen in the transport direction in said step c).
